(19) United States
(12) Patent Application Publication
(10) Pub. No.: US 2008/0172894 A1
(43) Pub. Date: Jul. 24, 2008

(54) Automatic leveling device

(75) Inventor: Chia-Wei Chang, Kaohsiung City (TW)

Correspondence Address: RABIN & Berdo, PC, 1101 14TH STREET, NW, SUITE 500, WASHINGTON, DC, 20005, US

(73) Assignee: MITAC INTERNATIONAL CORP., Taoyuan (TW)

(21) Appl. No.: 11/654,504

(22) Filed: Jan. 18, 2007

(51) Int. Cl. G01C 9/06

(52) U.S. Cl. 33/366.16

(57) ABSTRACT

An automatic leveling device is provided, which is disposed in an electronic device for adjusting the level of the electronic device. The automatic leveling device includes a liquid level gauge filled with a liquid and a bubble, a bubble position detection module for detecting a relative position of the bubble in the liquid level gauge, a control unit electrically connected to the bubble position detection module for receiving a bubble position signal from the bubble position detection module and outputting a leveling signal, and a drive unit electrically connected to the control unit for receiving the leveling signal from the control unit, thereby adjusting the electronic device to be at a level state.

### FIELD OF INVENTION

The present invention relates to an automatic leveling device, and more particularly, to an automatic leveling device with a liquid leveling instrument.

### RELATED ART

Just as the name implies, a leveling device is used to measure whether the plane or the outline of an object to be tested is at a level state, and adjust the object to be at a level state by utilizing the mechanism of the device. With the progress of science and technology industries, generally, electronic devices requiring a leveling accuracy, such as a projector and a scanner, all have a leveling device.

Referring to FIG. 1, it is a top view of a conventional leveling device. As shown in FIG. 1, in the conventional leveling device, four adjustment knobs 12 are disposed on a base 10 of an electronic device. When a user wants to adjust the level state of the electronic device, the user needs to turn the adjustment knobs 12 to adjust the heights by hand, and then determine whether the electronic device has already been located at a level state with the eyes. However, such leveling device is easily affected by the environment or the user, and thus, it is difficult to adjust the electronic device to be at the level state. For example, the electronic device is affected by an inclined table or floor on which it is placed, so if the user determines whether the electronic device is at a level state with the eyes, the leveling accuracy is relatively low. Furthermore, in order to adjust the electronic device to be at a level state, the electronic device should be adjusted once again when the environment in which the electronic device is placed is changed, and each time when the electronic device is used, the user must manually adjust the adjustment knobs 12, and after the previous user has adjusted the heights of the adjustment knobs 12, the next user may still possibly turn the adjustment knobs 12 again based upon his/her subjective judgment with the eyes, and thereby causing much trouble in operation.

In order to solve the aforementioned problems, Taiwan Patent Publication No. 472,479 discloses an automatic leveling device for a scanner. Referring to FIGS. 2A to 2D, FIG. 2A is a schematic view of a conventional automatic leveling device 40 applied in a scanner 30, and FIGS. 2B to 2D are schematic views of variation examples of the conventional automatic leveling device. As shown in FIG. 2A, four foot stands 32 are mounted below the conventional scanner 30. When the scanner 30 is used to scan a file, the focusing effect of a charge coupled device (CCD) in the scanner 30 must be considered first. Therefore, the file to be scanned should be flatly placed within the focal length of the CCD and the levelness of the scanner 30 should be ensured, so as to prevent the CCD from being out of the focus to cause a fuzzy scanned image of the file. Therefore, an automatic leveling device 40 is mounted above the surface of the scanner 30, so as to adjust the heights of the foot stands 32 to ensure the levelness of the scanner 30.

As shown in FIG. 2B, a trigger factor 42 is disposed on the surface of the conventional leveling device 40, which is a preferred conductor for a mercury ball or a metal ball to slide or roll thereon. When the scanner 30 is inclined by a specific tilt angle, i.e., the sliding force of the trigger factor 42 is larger than the static friction force, the trigger factor 42 begins sliding or rolling. Four sets of contact pads 44 are disposed around the automatic leveling device 40 corresponding to the four foot stands 32 respectively. When a certain contact pad 44 contacts the trigger factor 42, they are electrically conducted to each other, so as to output a signal to an automatic control system, to elongate or shorten the foot stands 32.

Since the surface space of the scanner 30 is quite limited, Taiwan Patent Publication No. 472,479 further discloses an automatic leveling device 50 with an efficiently reduced width. As shown in FIG. 2C, a trigger factor 52 and four sets of contact pads 54 corresponding to the four foot stands 32 are also disposed in the automatic leveling device 50, and the principle of controlling the foot stands 32 is the same as that mentioned above, which thus will not be described herein any more.

Of course, as for some scanners, only three foot stands are disposed below. Three points geometrically form a common plane, and thus, in order to correspond to the scanner with only three foot stands, Taiwan Patent Publication No. 472, 479 further discloses a triangular automatic leveling device 60. As shown in FIG. 2D, a trigger factor 62 and three sets of contact pads 64 respectively corresponding to the three foot stands are also disposed in the automatic leveling device 60, wherein the principle of controlling the foot stands is also the same as that mentioned above, which thus will not be described herein any more.

However, the aforementioned leveling methods can merely adjust an electronic device, such as a scanner, to be approximately at a level state, for example, when the environment where the electronic device is placed has a tilt angle that does not cause the aforementioned trigger factor 42, 52, or 62 be larger than the static friction force, the automatic leveling devices 40, 50, and 60 cannot achieve the automatic leveling effect. Furthermore, since the conventional automatic leveling device 40, 50, and 60 will not adjust the electronic device into a level state until the trigger factors 42, 52, and 62 contact the contact pads 44, 54, and 64. That is to say, the level state merely means that the trigger factors 42, 52, and 62 do not contact the contact pads 44, 54, and 64 through controlling the foot stands. However, when the electronic device is at a non-level state, the automatic leveling device may still possibly show that the electronic device is at a level state. Therefore, an automatic leveling device with a high accuracy and convenience in operation becomes a product to be urgently developed in the field.

### SUMMARY OF THE INVENTION

In view of the aforementioned problems, the present invention is directed to providing an automatic leveling device, which is disposed in an electronic device for adjusting the level of the electronic device.

According to the aforementioned object, the automatic leveling device provided by the present invention includes: a liquid level gauge, which is a sealed tube filled with a liquid and a bubble; a bubble position detection module, having a plurality of light sources disposed on one side of the liquid level gauge, and a plurality of bubble detection circuits disposed on the other side of the liquid level gauge corresponding to the light sources, wherein each of the bubble detection circuits has a photo detector for receiving lights emitted from the corresponding light source and outputting a bubble detection signal and a switch element electrically connected to the photo detector for receiving the bubble detection signal and outputting a corresponding switch signal; a control unit, electrically connected to the switch elements of the bubble detection circuits, for receiving the switch signals outputted from the switch elements and outputting a leveling signal; and a drive unit, electrically connected to the control unit, for receiving the leveling signal outputted by the control unit, so as to adjust the level state of the electronic device.

The automatic leveling device provided by the present invention solves the problem that the electronic device cannot be conveniently used in the application environment with a poor levelness, and thereby significantly enhancing the usage quality of the electronic device. Furthermore, the levelness of the electronic device can be accurately calculated regardless of the application environment, without being manually adjusted or determining the level state of the electronic device with the user's eyes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a top view of the conventional leveling device;

FIG. 2A is a schematic view of the conventional automatic leveling device being applied in a scanner;

FIG. 2B to 2D are schematic views of variation examples of the conventional automatic leveling device;

FIG. 3 is a schematic view of an automatic leveling device according to the present invention;

FIG. 4A is a schematic view of a liquid level gauge of the present invention, when the electronic device is not at a level state; and

FIG. 4B is a schematic view of the liquid level gauge of the present invention, when the electronic device is at a level state.

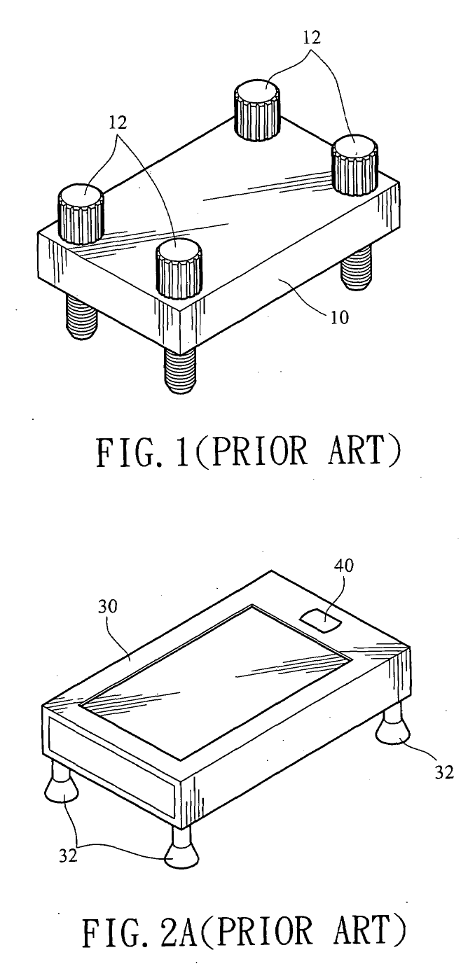

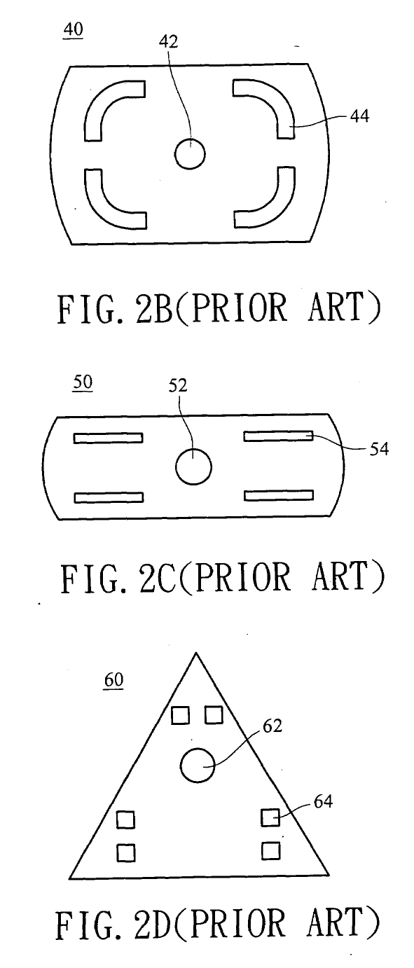

### DETAILED DESCRIPTION OF THE INVENTION

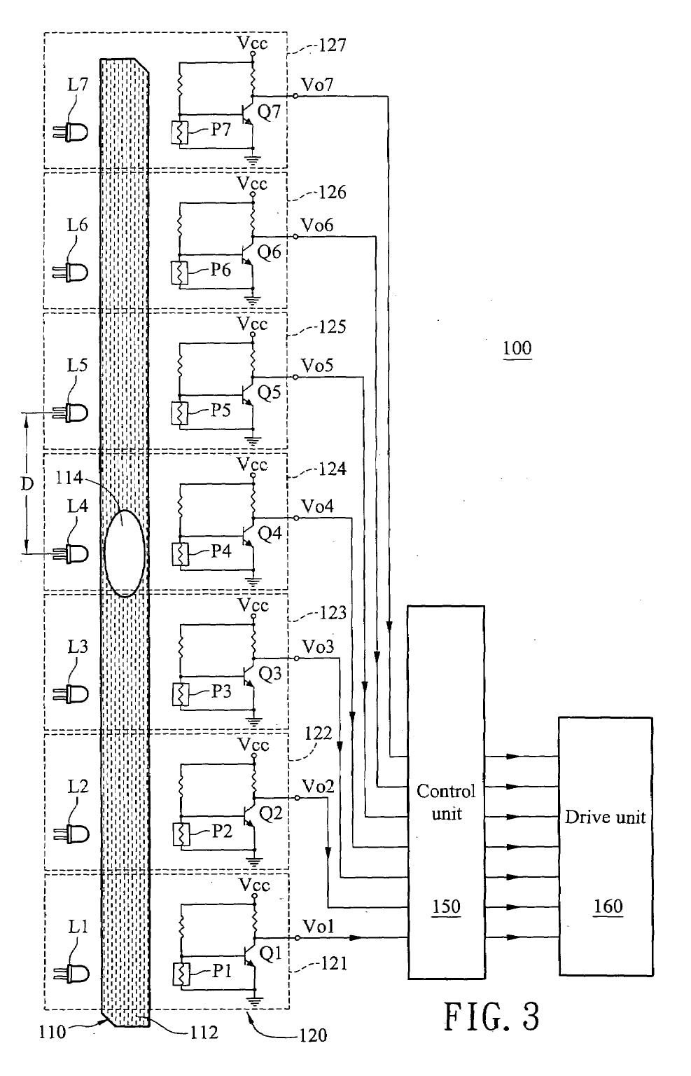

The automatic leveling device of the present invention is disposed on an electronic device such as a scanner and a projector, which is used for adjusting the electronic device to be at a level state. In the following description, the scanner is taken as an example of the electronic device for illustration. Referring to FIG. 3, it is a schematic view of an automatic leveling device 100 of the present invention. As shown in FIG. 3, the automatic leveling device 100 includes a liquid level gauge 110, a bubble position detection module 120, a control unit 150, and a drive unit 160.

The liquid level gauge 110 of the present invention is a sealed tube, wherein a black liquid 112 is filled in the tube and a space is reserved to form a bubble 114.

The bubble position detection module 120 of the present invention includes a plurality of light sources and a plurality of bubble detection circuits. In the present invention, the number of the bubble detection circuits is the same as that of the light sources, which is an odd number. In this embodiment, seven light sources L1 to L7 and seven bubble detection circuits 121 to 127 are utilized, which is convenient for illustrating the working principle of the automatic leveling device 100 of the present invention. In addition, the light sources L1 to L7 of the present invention are LED light sources disposed on one side of the liquid level gauge 110, and they are spaced apart from each other by a gap D. Since the number of the light sources in the present invention is an odd number, the light source L4 is disposed corresponding to the central position of the liquid level gauge 110, and the other light sources L1 to L3 and L5 to L7 are disposed on both sides of the light source L4 spaced apart by the gap D.

The bubble detection circuits 121 to 127 are disposed on the other side of the liquid level gauge 110 corresponding to the light sources L1 to L7, and each of the bubble detection circuits 121 to 127 is disposed with a photo detector P1 to P7, a switch element Q1 to Q7, and a constant voltage source Vcc respectively. In this embodiment, the photo detectors P1 to P7 are photoresistors made of Cadmium Sulfide (CdS), which are used to receive the light intensity emitted from the corresponding light sources L1 to L7 and convert it into a corresponding current value. In addition, in this embodiment, the switch elements Q1 to Q7 are transistors with the base electrically connected to the corresponding photo detectors P1 to P7 and with the collector and the emitter connected to the constant voltage source Vcc and grounded respectively. Furthermore, in this embodiment, the constant voltage source Vcc is 3.3 V. When the switch elements Q1 to Q7 receive the current transmitted from each of the photo detectors P1 to P7, the generated voltage difference is compared with the constant voltage source Vcc, such that each of the switch elements Q1 to Q7 outputs a corresponding voltage switch signal Vo1 to Vo7.

In this embodiment, the control unit 150 is an 8051 signal chip electrically connected to the collector of each of the switch elements Q1 to Q7, so as to receive the voltage switch signals Vo1 to Vo7 outputted from each of the switch elements Q1 to Q7 and output a corresponding leveling signal.

In this embodiment, the drive unit 160 is a step motor electrically connected to the control unit 150, so as to receive the leveling signal from the control unit 150 and adjust the level state of the electronic device.

The length of the bubble 114 for the liquid level gauge 110 of the present invention falls between a single gap D and double gaps 2D, i.e., D<the length of the bubble<2D, so as to make sure that the bubble 114 is irradiated by lights when it is located between two light sources. The reason why the liquid 112 is selected to be black mainly lies in that, the light transmittance generated by the lights irradiated onto the bubble 114 is significantly different from that of the lights irradiated onto the black liquid 112 when the liquid level gauge 110 is irradiated by the light sources P1 to P7, and particularly, if the black liquid 112 is irradiated by lights, the light transmittance is relatively poor and the light is relatively dark, and if the bubble 114 is irradiated by lights, the light transmittance is relatively good and the light is relatively bright. Furthermore, as the light irradiated onto the photo detectors P1 to P7 from the corresponding light sources L1 to L7 becomes brighter, the resistance of the photoresistors is reduced, otherwise, the resistance is increased.

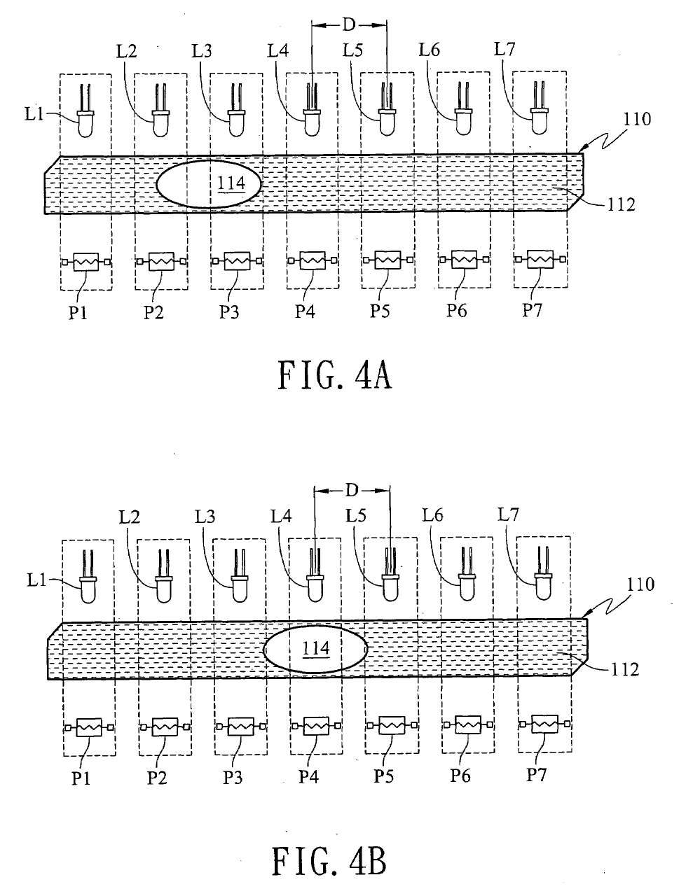

The working principle of the automatic leveling device 100 of the present invention is illustrated as follows. Referring to FIGS. 4A, 4B, and 3, FIG. 4A is a schematic view of the liquid level gauge 110 when the electronic device is not at a level state, and FIG. 4B is a schematic view of the liquid level gauge 110 after the electronic device is adjusted through the automatic leveling device 100 of the present invention. As shown in FIGS. 4A and 4B, when the electronic device tilts towards bottom right, i.e., the liquid level gauge tilts towards bottom right, the bubble moves to the left of the liquid level gauge 110. At this time, the resistances of the photo detectors P2 and P3 are too low to turn on the transistors Q2 and Q3, and thus, the voltage switch signals Vo2 to Vo3 outputted from the bubble detection circuits 122 and 123 are the voltage value of the constant voltage source Vcc, i.e., 3.3 V. Meanwhile, the resistances of the other photo detectors P1 and P4 to P7 are relatively high, such that the transistors Q1 and Q4 to Q7 are turned on, and thus, the voltage switch signals Vo1 and Vo4 to Vo7 outputted from the bubble detection circuits 121 and 124 to 127 are 0 V. Then, the control unit 150 receives the voltage switch signals Vo1 to Vo7 outputted from each of the bubble detection circuits 121 to 127 and determines which voltage value is 3.3 V, so as to know the position of the bubble 114, i.e., to know which side the liquid level gauge 110 tilts to, and then, a corresponding leveling signal is output to the drive unit 160 to adjust the corresponding height of the electronic device till the bubble 114 moves to the central position of the liquid level gauge, or till the voltage switch signal Vo4 outputted from the bubble detection circuit 124 is 3.3 V, which indicates that the electronic device is at a level state, as shown in FIG. 4B.

The automatic leveling device 100 of the present invention automatically adjusts the level state of the electronic device disposed with the automatic leveling device 100 once the electronic device is powered on. Of course, a drive button (not shown) may also be disposed in the electronic device to be electrically connected to the automatic leveling device 100, and once the user presses the drive button, the electronic device is automatically adjusted to be at a level state, which does not depart from the spirit of the present invention.

Compared with the prior art, the automatic leveling device of the present invention has the following efficacies: 1. solving the problem that the electronic device cannot be conveniently used under an application environment with poor levelness, thereby significantly enhancing the usage quality of the electronic device; 2. the levelness of the electronic device can be accurately calculated regardless of the application environments without being manually adjusted or determining the level state of the electronic device with the user's eyes.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An automatic leveling device, disposed in an electronic device for adjusting level of the electronic device, comprising:
a liquid level gauge, being a sealed tube filled with a liquid and a bubble;
a bubble position detection module, comprising:
a plurality of light sources, disposed on one side of the liquid level gauge; and
a plurality of bubble detection circuits, disposed on other side of the liquid level gauge corresponding to the light sources, wherein each of the bubble detection circuits includes a photo detector for receiving light emitted by the corresponding light source and outputting a bubble detection signal, and a switch element, electrically connected to the photo detector, for receiving the bubble detection signal and outputting a corresponding switch signal;
a control unit, electrically connected to the switch elements of the bubble detection circuits, for receiving switch signals outputted by the switch elements and outputting a leveling signal; and
a drive unit, electrically connected to the control unit, for receiving the leveling signal outputted by the control unit to adjust a level of the electronic device.

2. The automatic leveling device as claimed in claim 1, wherein the light sources are LED light sources.

3. The automatic leveling device as claimed in claim 1, wherein the photo detectors are photoresistors.

4. The automatic leveling device as claimed in claim 3, wherein the photoresistors are made of Cadmium Sulfide.

5. The automatic leveling device as claimed in claim 1, wherein the liquid filled in the liquid level gauge is a liquid with a color.

6. The automatic leveling device as claimed in claim 5, wherein the color of the liquid is black.

7. The automatic leveling device as claimed in claim 1, wherein the light sources are arranged by way of spacing part by a same predetermined gap, and a length of the bubble falls between a distance of the predetermined gap and that of double predetermined gaps.

8. The automatic leveling device as claimed in claim 1, wherein the bubble detection signal is a current signal.

9. The automatic leveling device as claimed in claim 1, wherein the bubble detection circuit further comprises a constant voltage source electrically connected to the switch element, when the switch element is turned on, the switch signal is zero, and when the switch element is turned off, a voltage value of the switch signal is voltage value of the constant voltage source.

10. The automatic leveling device as claimed in claim 9, wherein the switch element is a transistor.

11. The automatic leveling device as claimed in claim 1, wherein the control unit is a single chip.

12. The automatic leveling device as claimed in claim 1, wherein the drive unit is a step motor.

13. The automatic leveling device as claimed in claim 1, wherein number of the light sources is an odd number.

14. The automatic leveling device as claimed in claim 13, wherein the light sources comprise:
a primary source, disposed relative to a central position of the liquid level gauge; and a plurality of secondary sources, equidistantly disposed on both sides of the primary source;
wherein when the electronic device is at a level state, the bubble is located in center of the liquid level gauge, and when the bubble is not located in the center of the liquid level gauge, the drive unit adjusts the electronic device till the bubble is located in the center of the liquid level gauge.
